(19) United States
(12) Patent Application Publication
(10) Pub. No.: US 2025/0023457 A1
(43) Pub. Date: Jan. 16, 2025

(54) SWITCHING POWER SUPPLY APPARATUS

(71) Applicant: ROHM CO., LTD., Kyoto (JP)

(72) Inventors: Kazuhiro HORII, Kyoto (JP); Ryo KATO, Kyoto (JP)

(21) Appl. No.: 18/898,970

(22) Filed: Sep. 27, 2024

Related U.S. Application Data
(63) Continuation of application No. PCT/JP2023/011938, filed on Mar. 24, 2023.

(30) Foreign Application Priority Data
Mar. 31, 2022 (JP) 2022-059444

(51) Int. Cl. H02M 1/34; H02M 3/158

(52) U.S. Cl. CPC H02M 1/342; H02M 3/1588

(57) ABSTRACT

A main circuit of a switching power supply apparatus includes a switching element, and a rectifier element structured to conduct complementarily with the switching element. The snubber capacitor and the snubber diode are provided in series, on a path parallel to the rectifier element. The snubber switching element is connected in parallel with the snubber diode. The control circuit controls the switching element and the snubber switching element. The control circuit turns on the snubber switching element prior to turn-on of the switching element, and turns off the snubber switching element at the same time as or prior to turn-off of the switching element.

### BACKGROUND

### 1. Technical Field

The present disclosure relates to a switching power supply apparatus.

### 2. Description of the Related Art

Switching power supply apparatus such as DC (direct current)/DC converter (switching regulator) has been used to generate voltage higher or lower than given input voltage. The switching power supply apparatus includes a switching element (switching transistor) and a rectifier element structured to conduct complementarily with the switching element.

In this sort of switching power supply apparatus, the rectifier element will have serge voltage applied thereto, when the switching element turns on. If the rectifier element is suspected of having the surge voltage which exceeds the withstand voltage applied thereto, it is necessary to add a snubber circuit for suppressing the surge voltage.

A typical structure of the snubber circuit called RCD snubber circuit includes resistor, capacitor, and diode. The RCD snubber circuit is designed to absorb the surge voltage with the capacitor, and to consume the absorbed energy with the resistor, thereby causing a loss. Addition of the snubber circuit, therefore, degrades efficiency of the switching power supply apparatus.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram of a switching power supply apparatus according to an embodiment;

FIG. 2 is an operation waveform chart of the switching power supply apparatus illustrated in FIG. 1;

FIG. 3 is a circuit diagram of a switching power supply apparatus according to Example 1;

FIG. 4 is a circuit diagram illustrating an exemplary specific structure of the switching power supply apparatus illustrated in FIG. 3;

FIG. 5 is an operation waveform chart of the switching power supply apparatus illustrated in FIG. 4;

FIG. 6 is a circuit diagram of a switching power supply apparatus according to Example 2;

FIG. 7 is an operation waveform chart of the switching power supply apparatus illustrated in FIG. 6;

FIG. 8 is a circuit diagram of a switching power supply apparatus according to Example 3;

FIG. 9 is an operation waveform chart of the switching power supply apparatus illustrated in FIG. 8;

FIG. 10 is a circuit diagram of a switching power supply apparatus according to Example 4; and

FIG. 11 is a drawing illustrating efficiency of the switching power supply apparatus illustrated in FIG. 10.

### DESCRIPTION OF EMBODIMENTS

### Outline of Embodiments

Some exemplary embodiments of the present disclosure will be outlined. This outline is intended for briefing some concepts of one or more embodiments, for the purpose of basic understanding of the embodiments, as an introduction before detailed description that follows, without limiting the scope of the invention or disclosure. This outline is not an extensive overview of all possible embodiments, and is therefore intended neither to specify key elements of all embodiments, nor to delineate the scope of some or all of the embodiments. For convenience, the term “one embodiment” may be used to designate a single embodiment (Example or Modified Example), or a plurality of embodiments (Examples or Modified Examples) disclosed in the present specification.

A switching power supply apparatus according to one embodiment includes a main circuit including a switching element and a rectifier element structured to conduct complementarily with the switching element; a snubber capacitor and a snubber diode provided in series on a path in parallel with the rectifier element; a snubber switching element connected in parallel with the snubber diode; and a control circuit structured to control the switching element and the snubber switching element. The control circuit is structured to turn on the snubber switching element prior to turn-on of the switching element, and to turn off the snubber switching element at the same time as or prior to turn-off of the switching element.

In this structure, the surge energy generated upon turn-on of the switching element is stored in the snubber capacitor, thus suppressing the surge voltage from being applied to the rectifier element. In addition, since the snubber switching element turns on before the switching element turns on, so that the energy having been stored in the snubber capacitor in the previous switching cycle can be released to the output side, thus reducing unnecessary power loss.

In one embodiment, the control circuit may include a timing signal generation circuit structured to output a timing signal that instructs on/off of the switching element; and a switching element control circuit structured to generate a drive signal for the switching element, by delaying an edge of the timing signal that corresponds to turn-on of the switching element, by a predetermined time.

In one embodiment, the control circuit may include a timing signal generation circuit structured to output a timing signal that instructs on/off of the switching element; and
a snubber element control circuit structured to generate a drive signal for the snubber switching element in response to the timing signal.

In one embodiment, the control circuit may further include a switching element control circuit structured to generate a drive signal for the switching element, by delaying an edge of the timing signal that corresponds to turn-on of the switching element, by a predetermined time.

In one embodiment, the snubber switching element may be a P-channel field-effect transistor (FET), and the snubber element control circuit may include an inverter structured to invert the timing signal; and a high-pass filter structured to receive an output from the inverter.

In one embodiment, the rectifier element may be a synchronous rectifier element. The control circuit may further include a synchronous rectifier control circuit structured to receive the timing signal, and to drive the synchronous rectifier element.

In one embodiment, the rectifier element may be a synchronous rectifier element. The control circuit may include a timing signal generation circuit structured to output a timing signal that instructs on/off of the switching element; a synchronous rectifier control circuit structured to generate a drive signal for the synchronous rectifier element, in response to the timing signal; and a snubber element control circuit structured to generate a drive signal for the snubber switching element, in response to the drive signal for the synchronous rectifier element.

In one embodiment, the snubber element control circuit may include a high-pass filter structured to receive the drive signal for the synchronous rectifier element.

In one embodiment, the main circuit may constitute a step-down converter.

In one embodiment, the main circuit may constitute a full-bridge converter.

### Embodiments

Preferred embodiments will be explained below, referring to the attached drawings. All similar or equivalent constituents, members and processes illustrated in the individual drawings will be given same reference numerals, so as to properly avoid redundant explanations. The embodiments are merely illustrative, and are not restrictive about the invention. All features and combinations thereof described in the embodiments are not always necessarily essential to the disclosure and invention.

In the present specification, a “state in which a member A is coupled to a member B” includes a case where the member A and the member B are physically and directly coupled, and a case where the member A and the member B are indirectly coupled while placing in between some other member that does not substantially affect the electrically coupled state, or does not degrade the function or effect demonstrated by the coupling thereof.

Similarly, a “state in which a member C is provided between the member A and the member B” includes a case where the member A and the member C, or the member B and the member C are directly coupled, and a case where they are indirectly coupled, while placing in between some other member that does not substantially affect the electrically coupled state among the members, or does not degrade the function or effect demonstrated by the members.

In the present specification, reference signs attached to electric signals such as voltage signal and electric current signal, or circuit elements such as resistor and capacitor represent voltage value, current value, resistance, or capacitance of the individual components as necessary.

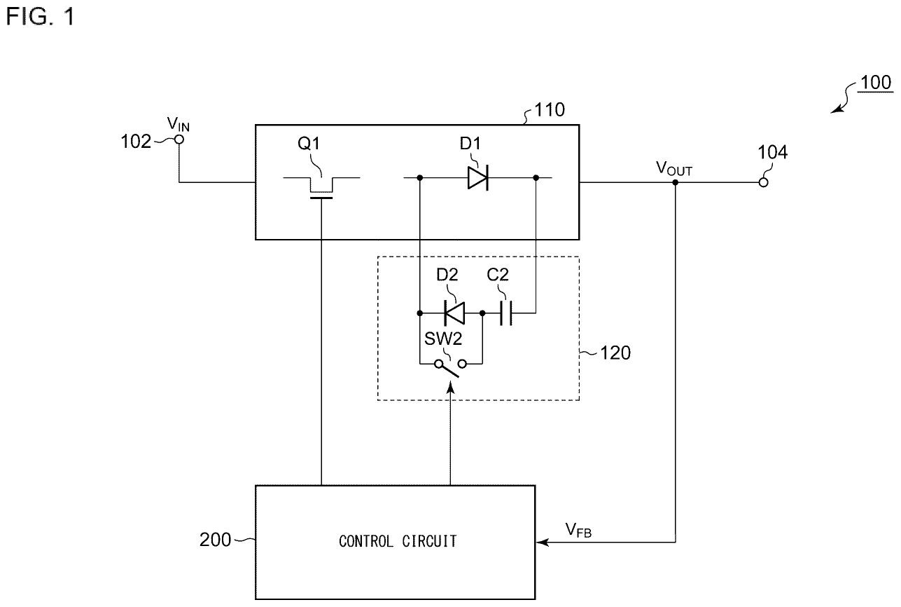

FIG. 1 is a circuit diagram of a switching power supply apparatus 100 according to an embodiment. The switching power supply apparatus 100 receives input voltage V_{IN} at an input terminal 102, boosts or steps down the input voltage V_{IN} to generate output voltage V_{OUT}, and supplies the output voltage V_{OUT} to a load (not illustrated) connected to an output terminal 104. The switching power supply apparatus 100 may output constant voltage or constant electric current. The switching power supply apparatus 100 may also be designed to give the output voltage V_{OUT} without feedback control applied thereto, that is, after being converted from the input voltage V_{IN} with a fixed conversion ratio to the output voltage V_{OUT} to be output.

The switching power supply apparatus 100 includes a main circuit 110, a snubber circuit 120, and a control circuit 200.

The main circuit 110 is an output circuit of the switching power supply apparatus 100, and includes at least a switching element Q1 and a rectifier element D1, which are structured to conduct complementarily. The main circuit 110 also includes an inductor (reactor), a transformer, and so forth. Topology of the main circuit 110 may be a step-down converter, a step-up converter, a step-up/down converter, a fly back converter, a forward converter, a full-bridge converter, or the like, without special limitation. The main circuit 110 may be either of insulating type or non-insulating type.

The snubber circuit 120 includes a snubber capacitor C2, a snubber diode D2, and a snubber switching element SW2.

The snubber capacitor C2 and the snubber diode D2 are provided in series, on a path parallel to the rectifier element D1. The snubber diode D2 is arranged so as to cause rectification in an inverted direction with respect to the rectifier element D1. The snubber capacitor C2 and the snubber diode D2 are interchangeable. The snubber switching element SW2 is connected in parallel with the snubber diode D2.

The control circuit 200 controls the switching element Q1 and the snubber switching element SW2. The control circuit 200 receives input of a feedback signal V_{FB} that indicates an electrical state of the main circuit 110 or an unillustrated load. The electrical state to be fed back may be the output voltage V_{OUT}, the output current I_{OUT}, or an internal signal of the load. In a case where the main circuit 110 is structured to convert, with a fixed conversion ratio, the input voltage V_{IN} to the output voltage V_{OUT} to be output, the control circuit 200 does not always necessarily have input of the feedback signal V_{FB}.

The control circuit 200 puts the switching element Q1 under switching control, so as to bring the feedback signal V_{FB} close to the reference voltage, in other words, so as to bring the electrical state of the main circuit 110 or the load close to a target state. The control circuit 200 also put the snubber switching element SW2 of the snubber circuit 120 under switching control, in synchronization with the switching control of the switching element Q1.

The control circuit 200 turns on the snubber switching element SW2, prior to turn-on of the switching element Q1. The control circuit 200 also turns off the snubber switching element SW2, at the same time as or prior to turn-off of the switching element Q1.

The structure of the switching power supply apparatus 100 has been described. Next, operations of the switching power supply apparatus 100 will be described.

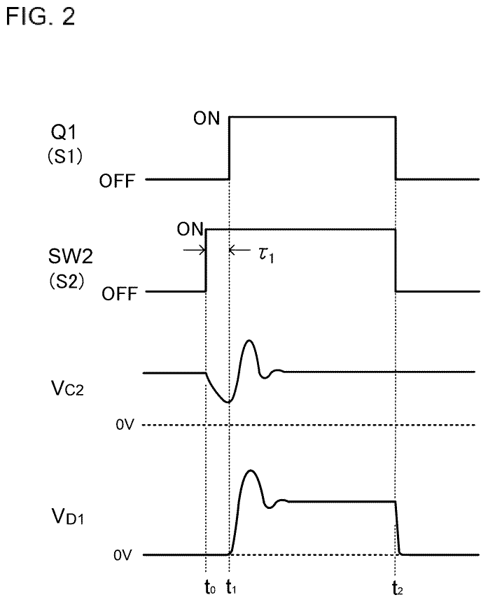

FIG. 2 is an operation waveform chart of the switching power supply apparatus 100 illustrated in FIG. 1. FIG. 2 illustrates a drive signal S1 supplied to the gate of the switching element Q1, a drive signal S2 for the snubber switching element SW2, voltage V_{c2} of the snubber capacitor C2, and a voltage V_{D1} of the rectifier element D1.

The switching element Q1 turns on at time t₁. The snubber switching element SW2 has already turned on at time t₀, which is a predetermined time τ₁ earlier than time t₁. Upon turn-on of the snubber switching element SW2, electric charge in the snubber capacitor C2 flows to the snubber switching element SW2, whereby the voltage V_{c2} of the snubber capacitor C2 drops.

Upon turn-on of the switching element Q1 at time t₁, surge energy is fed to rectifier element D1 so as to apply the serve voltage to the rectifier element D1, whereby the voltage V_{D1} would jump up. The jump up of the voltage V_{D1} of the rectifier element D1 is, however, suppressed in the switching power supply apparatus 100, since the surge energy is absorbed by the snubber capacitor C2.

Operations of the switching power supply apparatus 100 has been described. Next, advantages of the switching power supply apparatus 100 will be described.

In the switching power supply apparatus 100 of the embodiment, upon application of the surge energy to the rectifier element D1, the snubber switching element SW2 turns on earlier than time t₁ at which the surge voltage is applied to the rectifier element D1, whereby the electric charge having been stored in the snubber capacitor C2 in the previous cycle is discharged to reduce to the charge in the snubber capacitor C2. This means enhancement of the surge energy absorbing capability of the snubber capacitor C2. This embodiment is, therefore, advantageous over the RCD snubber, from the viewpoint of suppressing the surge voltage possibly applied to the rectifier element D1.

The RCD snubber has also been suffered from wasteful power consumption, since the electric charge having been stored in the snubber capacitor is discharged by the resistor. In contrast in this embodiment, the electric charge, having been stored in the snubber capacitor C2, flows to the output terminal 104, and can be extracted as effective electric power. That is, the loss can be reduced as compared with the RCD snubber.

The present disclosure may be understood by the block diagram of FIG. 1 or circuit diagrams, and encompasses various apparatuses and methods derived from the foregoing explanations, but not limited to a specific structure. Hereinafter, more specific exemplary structures and examples will be described to help understanding or to clarify the spirit or operations of the present disclosure, without narrowing the scope of the present disclosure.

### EXAMPLE 1

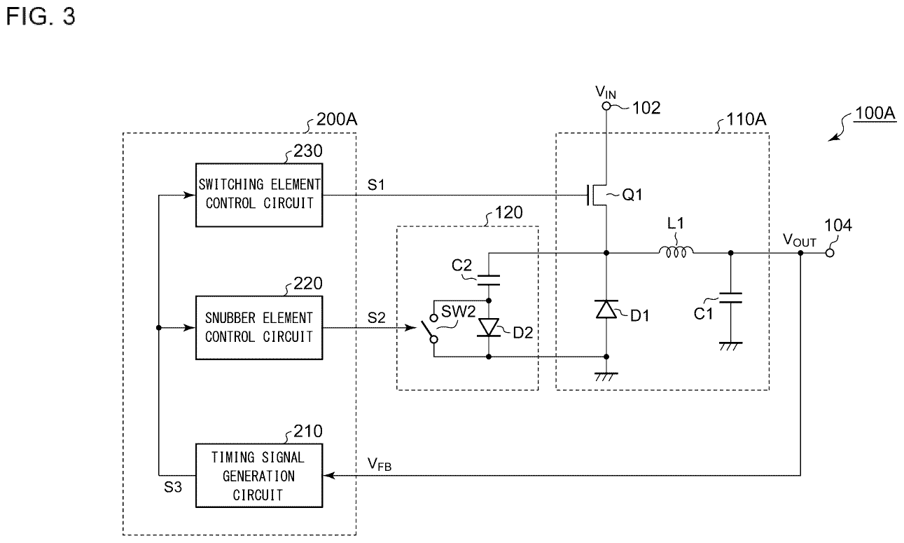

FIG. 3 is a circuit diagram of a switching power supply apparatus 100A according to Example 1. A main circuit 110A constitutes a step-down converter, and includes the switching element Q1, the rectifier element D1, an inductor L1, and an output capacitor C1.

A control circuit 200A includes a timing signal generation circuit 210, a snubber element control circuit 220, and a switching element control circuit 230. The Timing signal generation circuit 210 generates a timing signal S3 that instructs on/off of the switching element Q1. The timing signal generation circuit 210 constitutes a pulse width modulator or a pulse modulator, and generates the timing signal S3, so as to bring the feedback signal V_{FB} that corresponds to the output voltage V_{OUT} (or output current I_{OUT}) of the main circuit 110A, close to a target value. The structure of the timing signal generation circuit 210 may be any of voltage mode controller, an average current mode controller, or a peak current mode controller, without special limitation. The timing signal generation circuit 210 may alternatively be a ripple-controlled controller typically based on hysteresis control (bang-bang control), a bottom detection on-time fixed method, or a peak detection off-time fixed method.

The snubber element control circuit 220 generates the drive signal S2 for the snubber switching element SW2, in response to the timing signal S3.

Upon reception of the timing signal S3, the switching element control circuit 230 generates the drive signal S1 for the switching element Q1, by delaying an edge (the positive edge, for example) of the timing signal S3 that corresponds to turn-on of the switching element Q1, by a predetermined time.

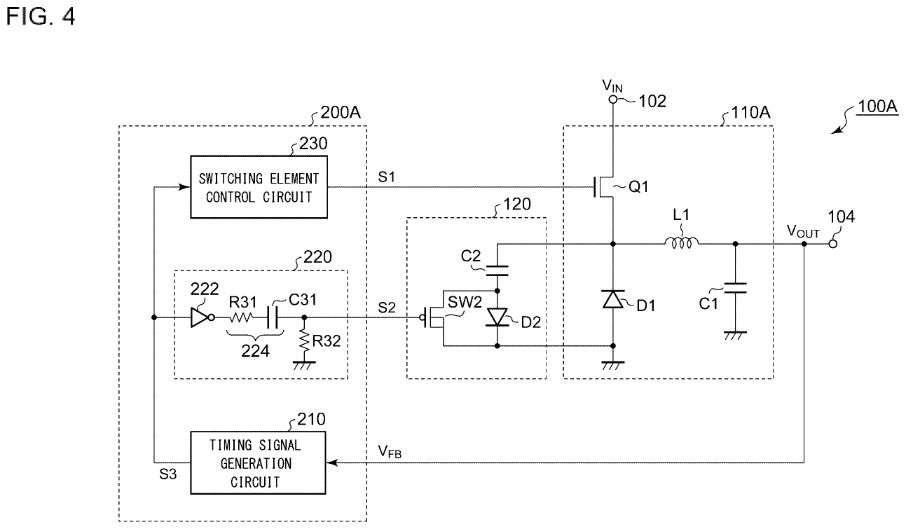

FIG. 4 is a circuit diagram illustrating an exemplary specific structure of the switching power supply apparatus 100A illustrated in FIG. 3. The snubber switching element SW2 is a P-channel field-effect transistor (FET), with the source grounded, and with the drain connected to the snubber capacitor C2. The P-channel FET which constitutes the snubber switching element SW2 has the gate, to which the drive signal S2 is input.

The snubber element control circuit 220 includes an inverter 222 and a filter 224. The inverter 222 inverts the timing signal S3. The filter 224 receives the output of the inverter 222, eliminates a DC component, and allows high frequency component to transmit therethrough. The filter 224 may be a high-pass filter (band-pass filter) that includes a resistor R31 and a capacitor C31.

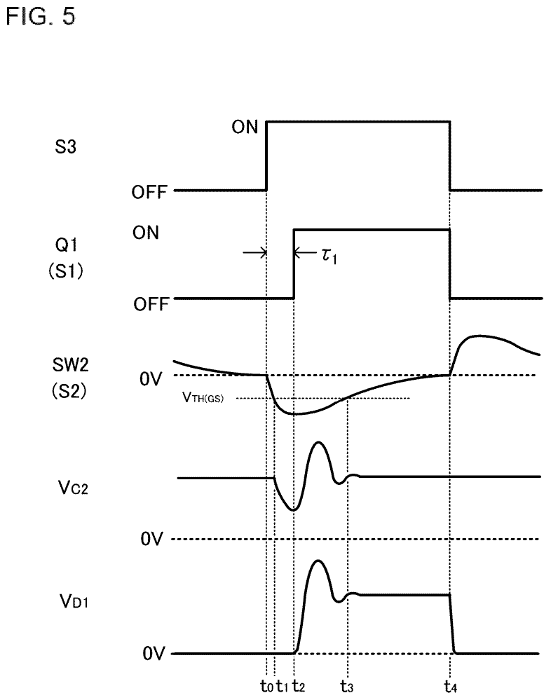

FIG. 5 is an operation waveform chart of the switching power supply apparatus 100A illustrated in FIG. 4. FIG. 5 illustrates the timing signal S3, the drive signal S1 supplied to the gate of the switching element Q1, the drive signal S2 for the snubber switching element SW2, voltage V_{c2} of the snubber capacitor C2, and voltage V_{D1} of the rectifier element D1.

At time t₀, the timing signal S3 transitions to an ON level (high level in this example) which corresponds to ON of the switching element Q1. The switching element control circuit 230 delays the positive edge of the timing signal S3 by a predetermined time τ₁, to generate the drive signal S1. The switching element Q1 turns on at time t₂, after the elapse of time τ₁ from time t₀.

The timing signal S3 is inverted by the snubber element control circuit 220, from which a DC component is eliminated. The drive signal S2 for the snubber switching element SW2 is thus generated. Upon drop of the drive signal S2, which is negative voltage, below the gate-source threshold voltage V_{TH(GS)} of the FET that constitutes the snubber switching element SW2 at time t₁ immediately after time t₀, the snubber switching element SW2 then turns on. This enables a turn-on operation of the snubber switching element SW2 prior to the switching element Q1.

Upon excess of the drive signal S2 over the threshold voltage V_{TH(GS)} at time t₃, the snubber switching element SW2 turns off.

Upon transition, at time t₄, of the timing signal S3 to an OFF level (low level in this example) which corresponds to OFF of the switching element Q1, the drive signal S1 then transitions to low. The switching element Q1 thus turns off.

In response to the transition of the timing signal S3 from the high level to the low level, the drive signal S2 for the snubber switching element SW2 changes towards positive voltage. This change does not affect the state of the snubber switching element SW2, thereby keeping the snubber switching element SW2 turned off.

### EXAMPLE 2

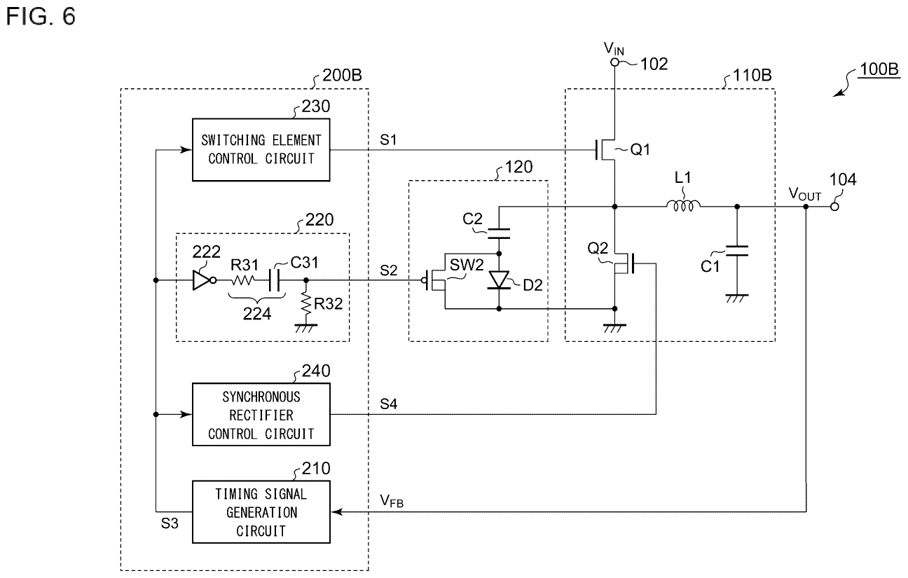

FIG. 6 is a circuit diagram of a switching power supply apparatus 100B according to Example 2. A main circuit 110B has a topology of a synchronous rectifier-type step-down converter, having a synchronous rectifier element Q2 as the rectifier element.

A control circuit 200B includes a synchronous rectifier control circuit 240, besides the timing signal generation circuit 210, the snubber element control circuit 220, and the switching element control circuit 230. The synchronous rectifier control circuit 240 drives the synchronous rectifier element Q2.

Upon reception of the timing signal S3, the synchronous rectifier control circuit 240 generates a drive signal S4 for the synchronous rectifier element Q2, by delaying an edge (the negative edge) of the timing signal S3 that corresponds to turn-off of the switching element Q1, by a predetermined time τ₂.

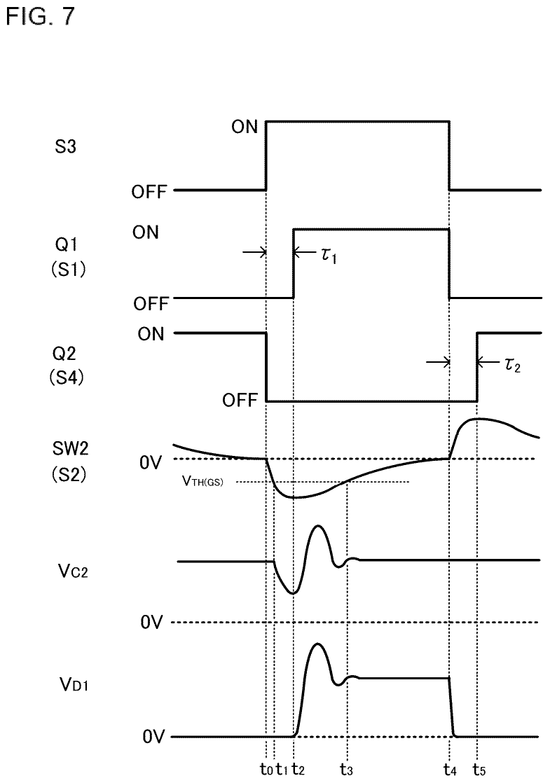

FIG. 7 is an operation waveform chart of the switching power supply apparatus 100B illustrated in FIG. 6. FIG. 7 illustrates the timing signal S3, the drive signal S1 supplied to the gate of the switching element Q1, the drive signal S2 for the snubber switching element SW2, the drive signal S4 supplied to the gate of the synchronous rectifier element Q2, voltage V_{c2} of the snubber capacitor C2, and voltage V_{D1} of the rectifier element D1.

Upon transition of the timing signal S3 to an ON level (high level) at time t₀, the drive signal S4 for the synchronous rectifier element Q2 transitions to a low level, and the synchronous rectifier element Q2 then turns off. Upon transition of the timing signal S3 to an OFF level (low level) at time t₄, the drive signal S4 transitions to a high level after the elapse of a predetermined time τ₂, and the synchronous rectifier element Q2 then turns on. That is, the delay times τ₁ and τ₂ represent dead times of the switching element Q1 and the synchronous rectifier element Q2, respectively.

### EXAMPLE 3

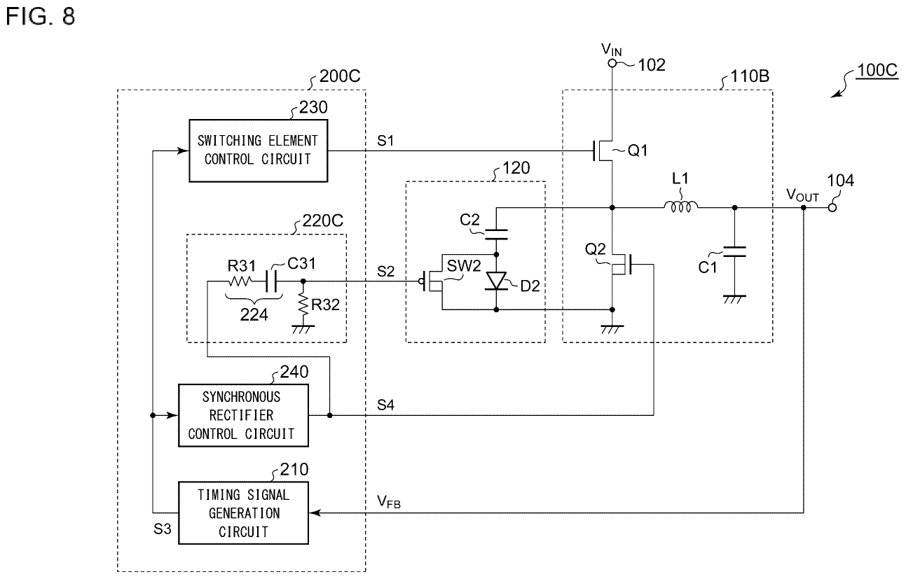

FIG. 8 is a circuit diagram of a switching power supply apparatus 100C according to Example 3. A snubber element control circuit 220C receives the drive signal S4 generated by the synchronous rectifier control circuit 240. The snubber element control circuit 220C includes a high-pass filter 224 that allows a high-frequency component of the drive signal S4 to pass therethrough, to generate the drive signal S2 for the snubber switching element SW2.

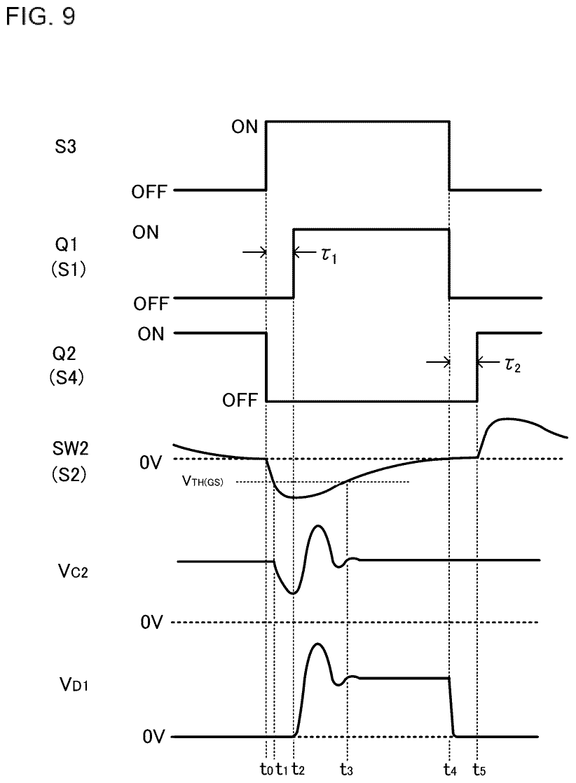

FIG. 9 is an operation waveform chart of the switching power supply apparatus 100C illustrated in FIG. 8. The drive signal S2 changes in the negative voltage direction in response to the negative edge of the drive signal S4 for the synchronous rectifier element Q2, meanwhile changes in the positive voltage direction in response to the positive edge of the drive signal S4.

### EXAMPLE 4

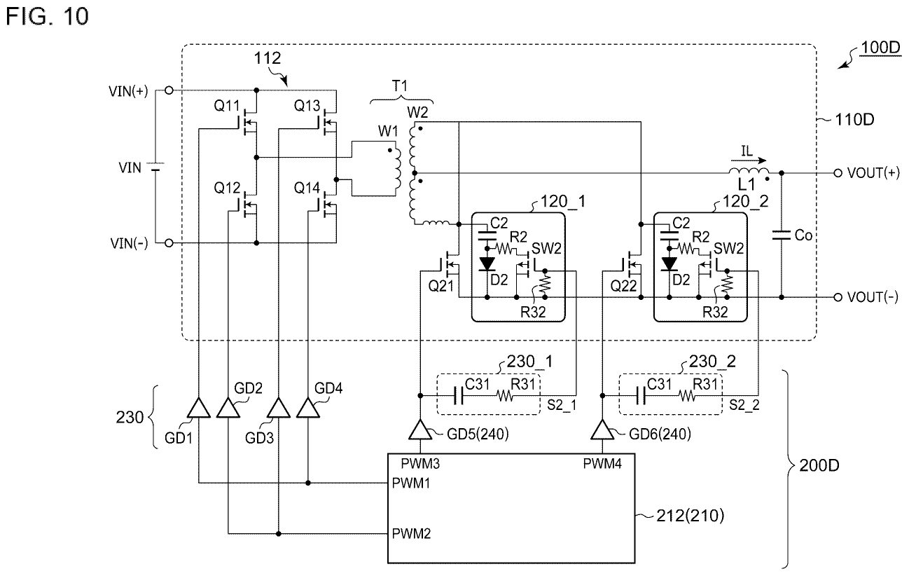

FIG. 10 is a circuit diagram of a switching power supply apparatus 100D according to Example 4. A main circuit 110D constitutes a full-bridge converter, and includes a transformer T1, a full-bridge circuit 112, synchronous rectifier elements (synchronous rectifier transistors) Q21 and Q22, the inductor L1, and an output capacitor Co.

The transformer T1 has a primary winding W1, to which the full-bridge circuit 112 is connected. The full-bridge circuit 112 includes switching elements Q11 to Q14. A control circuit 200D takes part in switching by which a pair of switching elements Q11 and Q14, and a pair of switching elements Q12 and Q13 are complementarily turned on.

The transformer T1 has a secondary winding W2, to which the synchronous rectifier elements Q21 and Q22 are connected. A snubber circuit 120_1 is connected to the synchronous rectifier element Q21, and a snubber circuit 120_2 is connected to the synchronous rectifier element Q22.

Each of the snubber circuits 120_1 and 120_2 is structured similarly to the snubber circuit 120 in FIG. 1, and includes the snubber capacitor C2, the snubber diode D2, and the snubber switching element SW2. In this embodiment, a resistor R2 is added to each of the snubber circuits 120_1 and 120_2, in series with the snubber switching element SW2. The resistor R2 is provided to control the discharge rate. The resistor R2 is omissible. Conversely, the resistor R2 may be provided in Examples 1 to 3, in series with the snubber switching element SW2.

A control circuit 200D drives the full-bridge circuit 112, the synchronous rectifier elements Q21 and Q22, and the snubber switching element SW2 of each of the snubber circuits 120_1 and 120_2.

The control circuit 200D includes a main controller 212, gate drivers GD1 to GD6, and switching element control circuit 230_1 and 230_2. The main controller 212 corresponds to the aforementioned timing signal generation circuit 210, and generates timing signals PWM1 to PWM4. The gate drivers GD1 to GD4 correspond to the switching element control circuit 230 in FIG. 3. The gate drivers GD1 and GD4 drive the switching elements Q11 and Q14, in response to the timing signal PWM1. The gate drivers GD2 and GD3 drive the switching elements Q12 and Q13, in response to the timing signal PWM2.

The gate driver GD5 receives the timing signal PWM3, and drives the synchronous rectifier element Q21. The gate driver GD6 receives the timing signal PWM4, and drives the synchronous rectifier element Q22. The gate drivers GD5 and GD6 correspond to the synchronous rectifier control circuit 240 in FIG. 8.

The switching element control circuits 230_1 and 230_2 in FIG. 10 are structured similarly to the snubber element control circuit 220C in FIG. 8. The switching element control circuit 230_1 receives a gate signal of the synchronous rectifier element Q21 generated by the gate driver GD5 which is the synchronous rectifier control circuit 240, and generates a drive signal for the snubber switching element SW2 of the snubber circuit 120_1. Similarly, the switching element control circuit 230_2 receives a gate signal of the synchronous rectifier element Q22 generated by the gate driver GD6 which is the synchronous rectifier control circuit 240, and generates a drive signal for the snubber switching element SW2 of the snubber circuit 120_2.

The structure of the switching power supply apparatus 100D has been described.

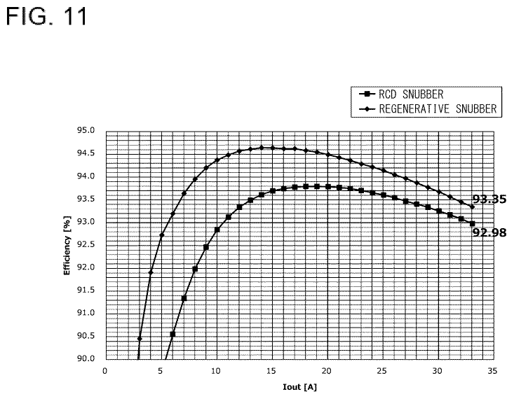

FIG. 11 is a drawing illustrating efficiency of the switching power supply apparatus 100D illustrated in FIG. 10. FIG. 11 also illustrates efficiency of a switching power supply apparatus that includes an RCD snubber circuit for comparison. Example illustrated in FIG. 10 can improve the efficiency over the entire range of output current, as compared with the RCD snubber circuit.

Note that the aforementioned embodiments are merely illustrative. A skilled person in the art will understand that combinations of the individual constituents or processes may be modified in various ways. Such modified examples will be explained below.

### Modified Example 1

The structure of the switching element control circuit 230_1 (230_2) in FIG. 10 may alternatively be changed similarly to the snubber element control circuit 220 in FIG. 6, so as to allow input of an internal signal of the main controller 212.

### Modified Example 2

The snubber switching element SW2 may alternatively be constituted by an N-channel FET. For the snubber switching element SW2 in this case, it suffices to invert the polarity of the drive signal S2.

### Modified Example 3

The topology of the main circuit 110 is not limited to that described in the embodiment. The main circuit 110 may constitute a half-bridge converter having a half-bridge circuit on the primary side. The rectifier on the secondary side may be a full-bridge rectifier or a current doubler synchronous rectifier.

Having described the embodiments according to the present disclosure with use of specific terms, the description is merely illustrative for better understanding, and by no means limits the disclosure or the claims. The scope of the present invention is defined by the claims, and therefore encompasses any embodiment, Example, and Modified Example having not been described above.

### APPENDIX

The following techniques are disclosed herein.
Item 1. A switching power supply apparatus including:
   a main circuit including a switching element and a rectifier element, the rectifier element being structured to conduct complementarily with the switching element;
   a snubber capacitor and a snubber diode provided in series on a path in parallel with the rectifier element;
   a snubber switching element connected in parallel with the snubber diode; and
   a control circuit structured to control the switching element and the snubber switching element, the control circuit being structured to turn on the snubber switching element prior to turn-on of the switching element, and to turn off the snubber switching element at the same time as or prior to turn-off of the switching element.
Item 2. The switching power supply apparatus according to item 1,
   wherein the control circuit includes:
   a timing signal generation circuit structured to output a timing signal that instructs on/off of the switching element; and
   a snubber element control circuit structured to generate a drive signal for the snubber switching element, in response to the timing signal.
Item 3. The switching power supply apparatus according to item 2,
   wherein the control circuit further includes a switching element control circuit structured to generate a drive signal for the switching element, by delaying an edge of the timing signal that corresponds to turn-on of the switching element, by a predetermined time.
Item 4. The switching power supply apparatus according to item 3,
   wherein the snubber switching element is a P-channel field-effect transistor (FET), and,
   the snubber element control circuit includes:
   an inverter structured to invert the timing signal; and
   a high-pass filter structured to receive an output from the inverter.
Item 5. The switching power supply apparatus according to any one of items 2 to 4, wherein the rectifier element is a synchronous rectifier element, and,
   the control circuit further includes a synchronous rectifier control circuit structured to receive the timing signal, and to drive the synchronous rectifier element.
Item 6. The switching power supply apparatus according to item 1,
   wherein the rectifier element is a synchronous rectifier element, and,
   the control circuit includes:
   a timing signal generation circuit structured to output a timing signal that instructs on/off of the switching element;
   a synchronous rectifier control circuit structured to generate a drive signal for the synchronous rectifier element, in response to the timing signal; and
   a snubber element control circuit structured to generate a drive signal for the snubber switching element, in response to the drive signal for the synchronous rectifier element.
Item 7. The switching power supply apparatus according to Item 6,
   wherein the snubber element control circuit includes a high-pass filter structured to receive the drive signal for the synchronous rectifier element.
Item 8. The switching power supply apparatus according to any one of items 1 to 7, wherein the main circuit constitutes a step-down converter.
Item 9. The switching power supply apparatus according to any one of items 1 to 7, wherein the main circuit constitutes a full-bridge converter.

What is claimed is:

1. A switching power supply apparatus comprising:
a main circuit including a switching element and a rectifier element, the rectifier element being structured to conduct complementarily with the switching element;
a snubber capacitor and a snubber diode provided in series on a path in parallel with the rectifier element;
a snubber switching element connected in parallel with the snubber diode; and
a control circuit structured to control the switching element and the snubber switching element, the control circuit being structured to turn on the snubber switching element prior to turn-on of the switching element, and to turn off the snubber switching element at the same time as or prior to turn-off of the switching element.

2. The switching power supply apparatus according to claim 1,
wherein the control circuit comprises:
a timing signal generation circuit structured to output a timing signal that instructs on/off of the switching element; and
a snubber element control circuit structured to generate a drive signal for the snubber switching element, in response to the timing signal.

3. The switching power supply apparatus according to claim 2,
wherein the control circuit further comprises
a switching element control circuit structured to generate a drive signal for the switching element, by delaying an edge of the timing signal that corresponds to turn-on of the switching element, by a predetermined time.

4. The switching power supply apparatus according to claim 3,
wherein the snubber switching element is a P-channel field-effect transistor (FET), and,
the snubber element control circuit comprises:
an inverter structured to invert the timing signal; and
a high-pass filter structured to receive an output from the inverter.

5. The switching power supply apparatus according to claim 2,
wherein the rectifier element is a synchronous rectifier element, and
the control circuit further comprises
a synchronous rectifier control circuit structured to receive the timing signal and to drive the synchronous rectifier element.

6. The switching power supply apparatus according to claim 1,
wherein the rectifier element is a synchronous rectifier element, and
the control circuit comprises:
a timing signal generation circuit structured to output a timing signal that instructs on/off of the switching element;
a synchronous rectifier control circuit structured to generate a drive signal for the synchronous rectifier element, in response to the timing signal; and
a snubber element control circuit structured to generate a drive signal for the snubber switching element, in response to the drive signal for the synchronous rectifier element.

7. The switching power supply apparatus according to claim 6,
wherein the snubber element control circuit comprises a high-pass filter structured to receive the drive signal for the synchronous rectifier element.

8. The switching power supply apparatus according to claim 1, wherein the main circuit constitutes a step-down converter.

9. The switching power supply apparatus according to claim 1, wherein the main circuit constitutes a full-bridge converter.
